(19) United States
(12) Patent Application Publication
(10) Pub. No.: US 2006/0179326 A1
(43) Pub. Date: Aug. 10, 2006

(54) Security device using multiple operating system for enforcing security domain

(76) Inventor: Kwok-Yan Leung, Willowdale (CA)

Correspondence Address: LIN & ASSOCIATES INTELLECTUAL PROPERTY, P.O. BOX 2339, SARATOGA, CA, 95070-0339, US

(21) Appl. No.: 11/055,192

(22) Filed: Feb. 10, 2005

(51) Int. Cl. G06F 12/14

(52) U.S. Cl. 713/193

(57) ABSTRACT

A security device using multiple operating systems for enforcing security domain policies is provided. The device is installed in a computing device having a hard disk drive and allows multiple operating systems to be installed on the hard disk drive, each of which is configured to communicate only with computing devices in a specific security domain. The device contains a disk controller and a network port group. The disk controller issues a selection signal to the network port group when a user decides to boot the computing device with a specific operating system. The network port group contains at least two network ports, each of which is connected to different security domains respectively. After receiving the selection signal from the disk controller, the network port group would only allow the computing device to communicate to a specific domain via the corresponding network port.

### BACKGROUND OF THE INVENTION

1. Field of the Invention

The present invention generally relates to security devices, and more particularly to a security device using multiple operating systems for enforcing security domain policies.

2. The Prior Arts

FIG. 1 is a schematic diagram showing the structure of a conventional local area network. As illustrated, the local area network contains two network segments 10 and 12. The network segment 10 further contains computing devices 101 and 102; the network segment 12 further contains computing devices 121 and 122. These computing devices are able to exchange data between each other and to access the Internet via the hub/switches 14, 16, and the router 18.

Typically, an additional firewall device (not shown) is installed in the local area network illustrated in FIG. 1 to protect the computing devices 101, 102, 121, 122 from unauthorized access and hacking. However, it is already a known fact that firewall devices, no matter how advanced they are, could not guarantee a perfectly hack-free environment.

Therefore, in addition to using firewall devices, there are also proposals for partitioning the local area network into several security domains and enforcing different security policies in different security domains. For example, the local area network illustrated in FIG. 1 could be partitioned into workgroup domains, organization domains, and public domains. For example, the Internet belongs to a public domain, the network segments 10 and 12 are two separate workgroup domains, and all others belong to an organization domain. By such an arrangement, security policies could be enforced such that, for example, only the computing devices 101, 102 within the same workgroup domain could access each other, and such access is entirely denied for computing devices belonging to the organization domain and the public domain.

However, as each computing device uses only a single network cable for connection to the local area network and the Internet, some form of packet filtering is required so that illegal packets from unauthorized sources could be filtered. As could be imagined, such packet filtering must slow down the network communication performance. In addition, packet filtering is not an entirely bulletproof security measure.

There are also circumstances that a computing device is required to switch between security domains from time to time. There are therefore proposals for installing multiple operating systems (such as DOS®, Linux®, Windows98®, WindowsXP®, etc.) on a single computing device with each operating system configured to operate within a different security domain respectively. When the computing device is booted up, a user could choose which operating system to use based on the user's operation requirement. In this way, for example, a user could choose to run the computing device 101 with a specific operating system so that it could only exchange data with the computing device 102, and the security domain policies are thereby enforced.

To install multiple operating systems on a single computing device, however, there is usually an installation sequence. For example, if WindowsXP® is installed first, then Windows98® couldn't be installed later. In addition, within a conventional multiple-operating-system environment, to restore an operating system backed up by software programs such as Ghost®, other operating systems would usually be damaged.

### SUMMARY OF THE INVENTION

The major objective of the present invention is to provide a security device based on multiple operating systems configured for specific security domains. The present invention, without requiring packet filtering and impact to the communications performance, achieves a kind of a storage firewall.

Another objective of the present invention is to provide a security device that utilizes multiple operating systems to communicate with their specific security domains with separate network connections. The present invention allows a user to choose a specific operating system to boot and still achieves a kind of a storage firewall.

Yet another objective of the present invention is to provide a security device that utilizes domain identifier devices to prevent an operating system's corresponding network port from connecting to a wrong security domain and to prevent unauthorized access from packets issued from an unknown source. The present invention thereby achieves a kind of a network firewall.

Still another objective of the present invention is to provide a security device that takes control of the hard disk drive by providing a logical block to central processing unit (CPU). The present invention therefore allows multiple operating systems to be installed in a hard disk drive without requiring a specific installation sequence, and the operating systems do not interfere with each other.

One other objective of the present invention is to provide a security device which, by means of user authentication, to prevent unauthorized user to access privileged security domains. The present invention therefore achieves a kind of a user firewall.

In order to achieve the foregoing objectives, the device of the present invention is installed in a computing device having a hard disk drive. The device allows multiple operating systems to be installed on the hard disk drive and each operating system is allowed to communicate with a specific security domain only.

The device contains a disk controller and a network port group. Among them, the disk controller partitions the hard disk drive space into at least a working area and a backup area. Under a configuration mode of the disk controller, multiple operating systems could be installed into separate system areas within the working area. In another backup mode, the disk controller backs up the operating systems and their associated data within each system area into the backup area of the hard disk drive. Then, in the protection mode, when a user chooses to boot the computing device with a specific operating system the disk controller would limit the disk access to the disk space allocated to that specific operating system. In addition, the disk controller would issue a selection signal to the network port group. The network port group contains at least two network ports, each of which is connected to a different security domain respectively. Upon receiving the selection signal, the network port group would limit the computing device to communicate only with a specific security domain via its corresponding network port.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing the structure of a conventional local area network.

FIG. 2 is a schematic diagram showing a structure of a local area network according to the present invention.

FIG. 3a is a schematic diagram showing the structure of the security device according to a first embodiment of the present invention.

FIG. 3b is a schematic diagram showing the structure of the security device according to a second embodiment of the present invention.

FIG. 4 is a schematic diagram showing the structure of the security device according to a third embodiment of the present invention.

FIG. 5 is a schematic diagram showing the components of the disk controller according to the present invention.

FIG. 6 is a schematic diagram showing the disk space allocation of a hard disk drive according to the present invention.

FIG. 7 is a schematic diagram showing the internal space allocation of the hard disk drive's working area according to the present invention.

FIG. 8 is a schematic diagram showing the structure of the disk controller according to the present invention.

### DETAILED DESCRIPTION OF THE PREFERRED EMBODIMENTS

In the following, detailed description along with the accompanied drawings is given to better explain preferred embodiments of the present invention. Please be noted that, in the accompanied drawings, some parts are not drawn to scale or are somewhat exaggerated, so that people skilled in the art can better understand the principles of the present invention.

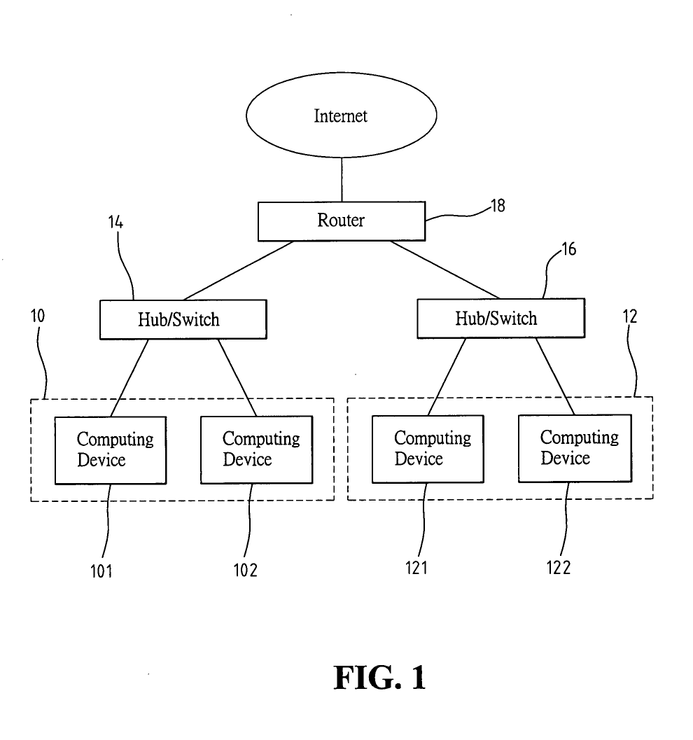

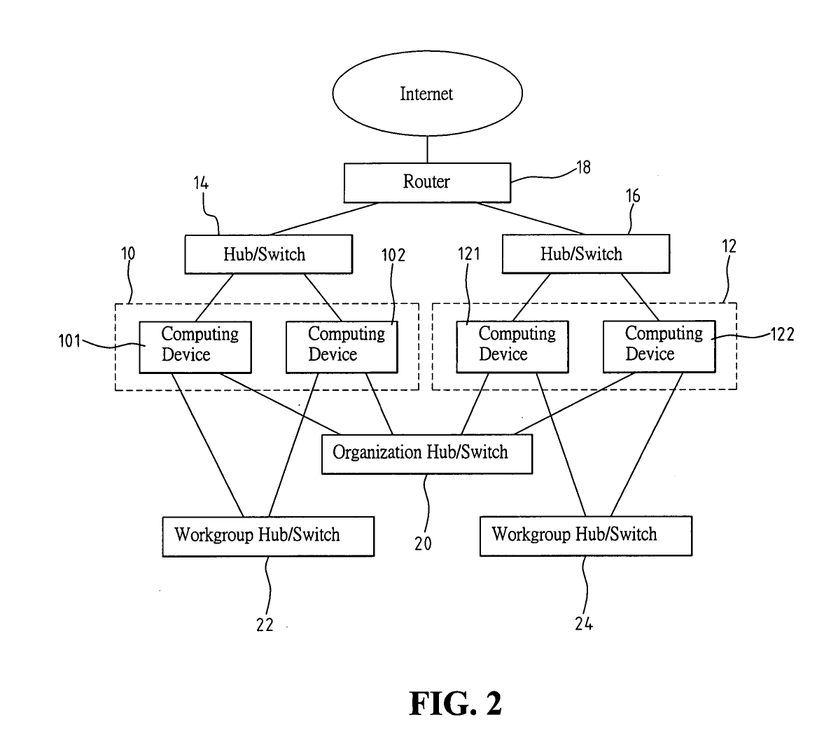

FIG. 2 is a schematic diagram showing a structure of a local area network according to the present invention. As illustrated, computing devices 101, 102 of the network segment 10, and computing devices 121, 122 of the network segment 12, similar to what is shown in FIG. 1, access the Internet via the hubs/switches 14, 16 respectively. In addition, there is a hub/switch 22 dedicated for workgroup domain communications between the computing devices 101 and 102, and there is another hub/switch 24 dedicated for workgroup communications between the computing devices 121 and 122. Similarly, there is a hub/switch 20 linking network segments 10 and 12 dedicated for organization domain communication. The computing device 101, for example, is able to communicate with other computing devices within its workgroup domain, the organization domain, and the public domain through the hubs/switches 22, 24, and 20 respectively. In the following, the computing device 101 would be used as an example for explaining how the structure depicted in FIG. 2 fulfills the objectives of the present invention.

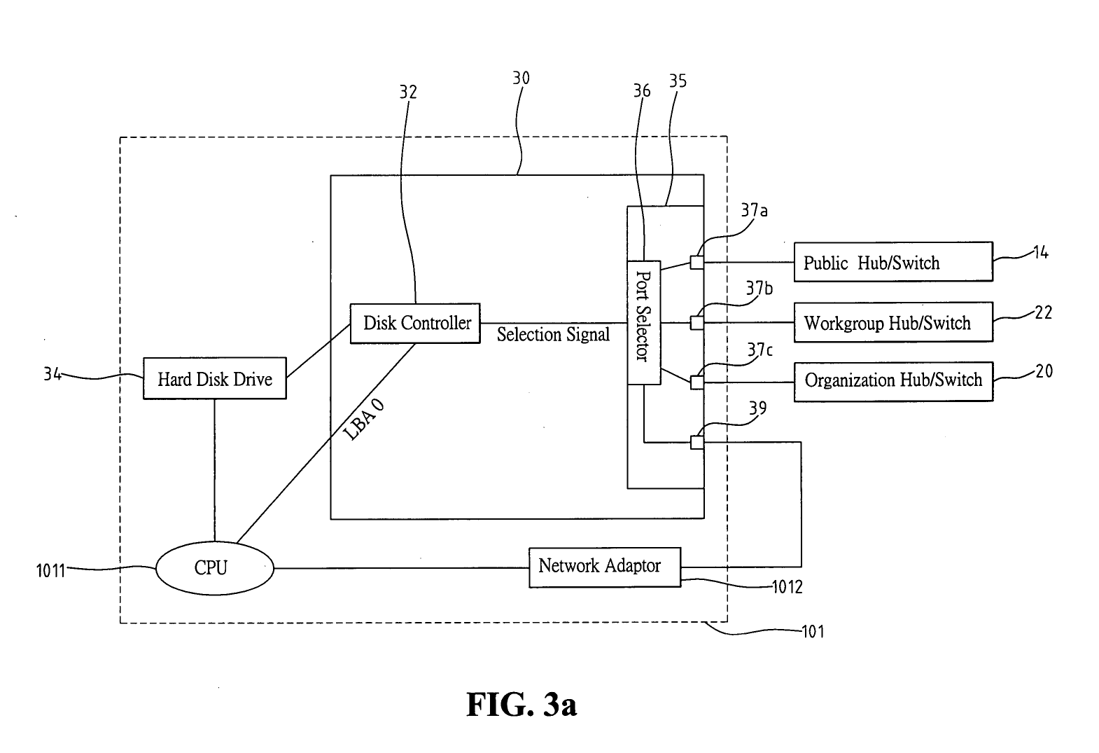

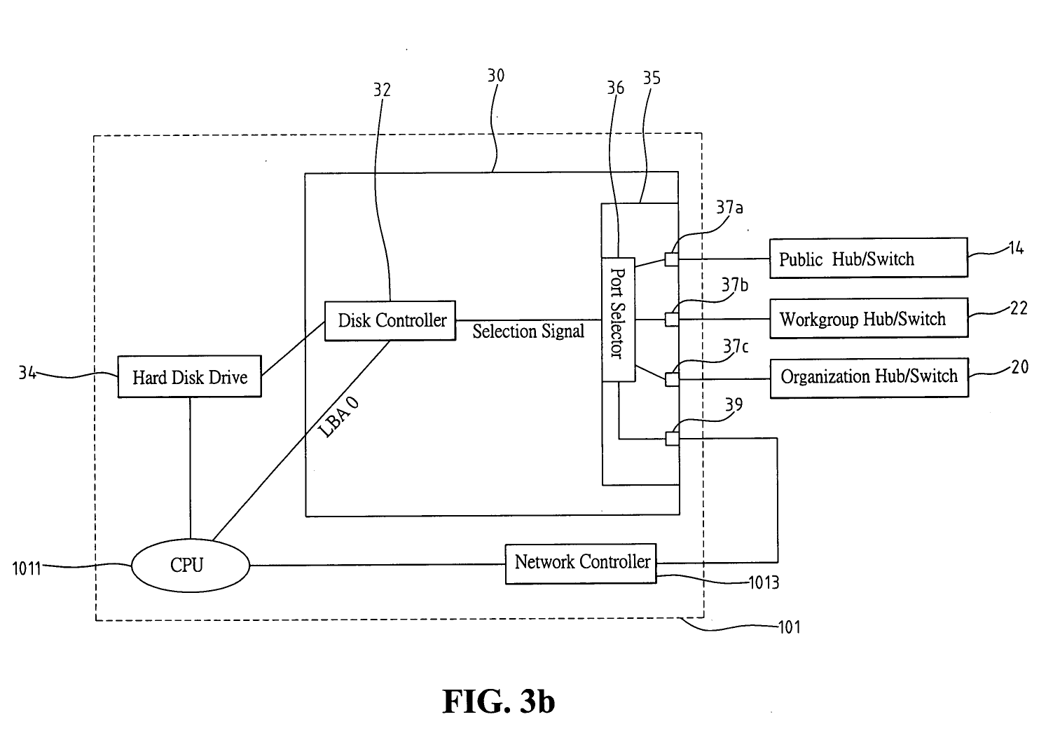

Please refer to FIG. 3a, which is a schematic diagram showing the structure of the security device according to a first embodiment of the present invention. As shown in FIG. 3a, the security device 30 of the present invention is installed in the computing device 101 having a hard disk drive 34. The security device 30 contains at least a disk controller 32 and a network port group 35. The network port group 34 has a number of network ports 37a, 37b, 37c, which are connected to the public domain hub/switch 14, workgroup domain hub/switch 22, and organization domain hub/switch 20, respectively.

In short, the disk controller 32 allows the hard disk drive 34 to install at least two operating systems. The disk controller 32 also controls an operating system to communicate only with a corresponding security domain. For example, an operating system A installed on the hard disk drive 34, when run on the computing device 101, would only use the network port 37a to communicate with other computing devices in the public domain via the hub/switch 14. In this way, security domains are enforced while packet filtering is not necessary and the performance of network communications is not affected. Since the hard disk drive 34 is partitioned and an operating system couldn't access the data stored within other operating systems' partitions, a kind of storage firewall is achieved.

Since each operating system installed on the hard disk drive 34 has a corresponding security domain, when a user chooses a specific operating system when booting up the computing device 101, the disk controller 32 would send a selection signal to the port selector 36 of the network port group 35. Based on the operating system to run and its corresponding security domain, the selection signal would cause the port selector 36 to establish a communication path between an internal port 39 and one of the network ports 37a, 37b, and 37c. In other words, the port selector 36, based on the selection signal, could selectively control the computing device 101 to conduct its external communications to a specific security domain.

A more detailed scenario is described as follows. The operating system A installed on the hard disk drive 34 is allowed to operate within the public domain only. When a user choose to run operating system A during boot up, disk controller 32 issues a selection signal to the port selector 36 so that the network port 37a is connected to the internal port 39. To communicate with other computing devices, the CPU 1011 of the computing device 101 prepares the data into packets and the packets travel from the network adaptor 1012, via internal port 39, port selector 36, network port 37a, hub/switch 14, and finally to the public domain. Similarly, packets sent from a computing device within the public domain to the computing device 101 would travel through hub/switch 14, network port 37a, port selector 36, internal port 39, and finally to the network adaptor 1012.

As shown in FIG. 3b, which is a schematic diagram showing the structure of the security device according to a second embodiment of the present invention, the internal port 39 and the network adaptor 1012 depicted in FIG. 3a is replaced by a network controller 1013. The network controller 1013 processes packets and connects to the port selector 36. In other words, in FIG. 3a, the security device 30 is integrated into the computing device 101 that already has a built-in network adaptor 1012. In the present embodiment, as shown in FIG. 3b, the computing device 101 does not have any built-in network capability and it relies on the security device 30 for its network communications.

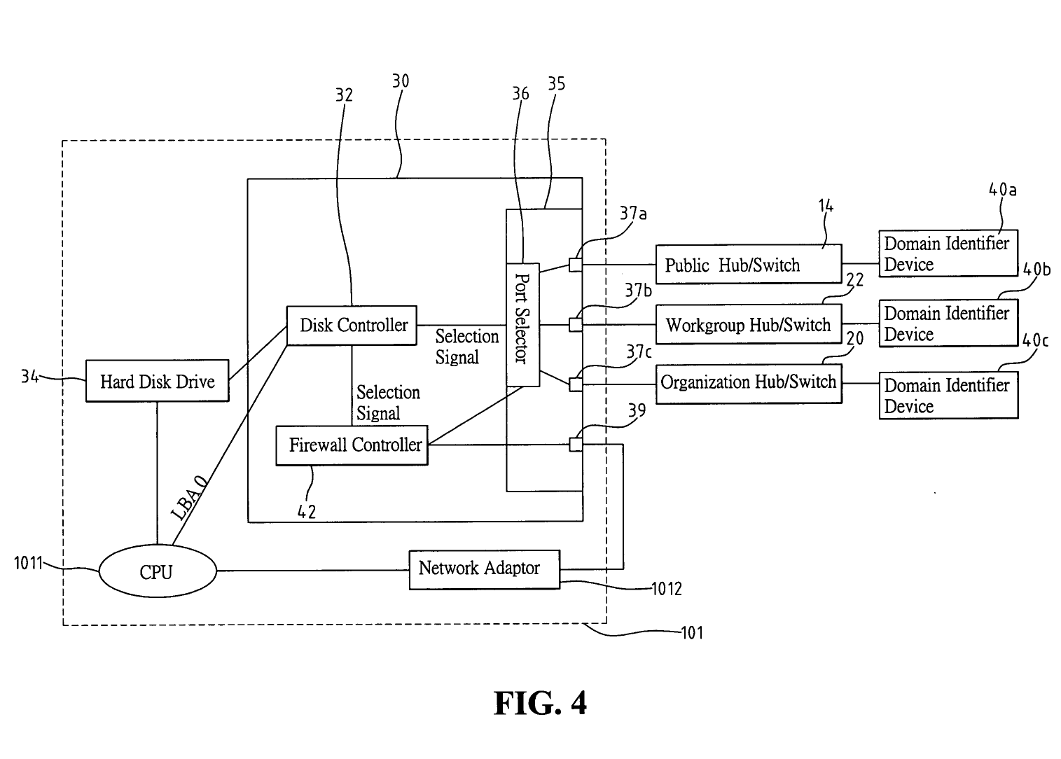

Please refer to FIG. 4, which is a schematic diagram showing the structure of the security device according to a third embodiment of the present invention. As illustrated, a firewall controller 42 is located between the internal port 39 and the port selector 36. In addition, there are a number of domain identifier devices 40a, 40b, 40c installed in the public, workgroup, and organization domains respectively. The domain identifier devices would issue identifier packets containing information about the domains they are located.

Based on a selection signal issued from the disk controller 32, the firewall controller 42 is able to know which security domain that the computing device 101 is supposed to operate within. The firewall controller 42 then examines the packets flowing through to see if the identifier packets are indeed issued from the specific security domain. For example, operating system A is supposed to run within the public domain and the computing device 101 should connect its network port 37a to the hub/switch 14. If the computing device 101 mistakenly connects its network port 37a to the workgroup domain hub/switch 22, when operating system A is running, the firewall controller 42 would receive an identifier packet from the domain identifier device 40b, specifying that it is from the workgroup domain, which contradicts to the selection signal the firewall controller 42 has received earlier. The firewall controller 42 then would stop the computing device 101 from sending and receiving any network packets. In other words, the use of the domain identifier devices prevents the computing device 101 from communicating with the wrong domains, and guards against the illegal access to the computing device 101 through packets from unknown sources. A kind of network firewall is thereby achieved.

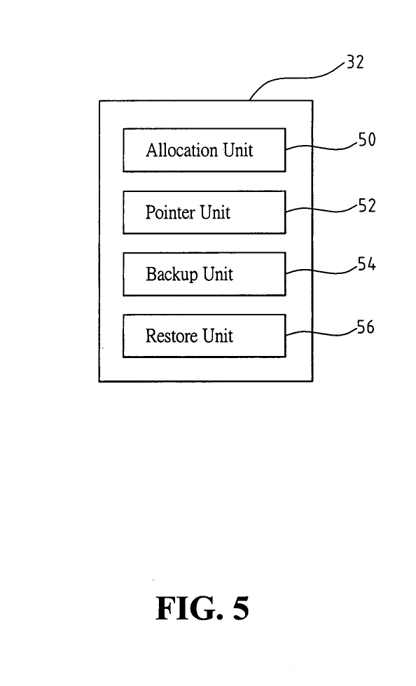

Please refer to FIG. 5, which is a schematic diagram showing the components of the disk controller according to the present invention. The disk controller 32 forms a secured, multiple operating system environment on the hard disk drive 34. As illustrated, the disk controller 32 further contains an allocation unit 50, a pointer unit 52, a backup unit 54, and a restore unit 56.

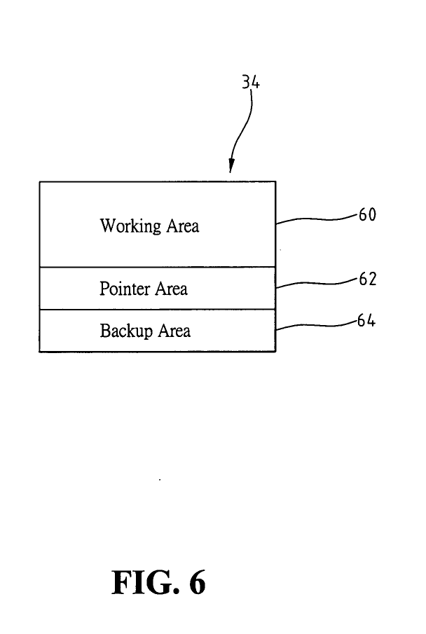

Please refer to FIG. 6, which is a schematic diagram showing the disk space allocation of a hard disk drive according to the present invention. The allocation unit 50 of FIG. 5, based on allocation commands, structures the hard disk drive 34's blocks into the working area 60, pointer area 62, and backup area 64, as illustrated in FIG. 6. The pointer unit 52, when data is written into the working area 60 under the configuration mode, would record the block status (i.e., whether a specific block has been written with data) in the pointer area 62. The backup unit 54, on the other hand, saves a backup copy of all blocks written with data (as pointed out by the block status information stored in the pointer area 62) within the working area 60, and the block status information in the pointer area 62, in the backup area 64. The restore unit 56, on the other hand, based on the backup copy saved by the backup unit 54 in the backup area 64, restores the working area 60 and the pointer area 62 back to the state when that backup copy is made in the backup area 64.

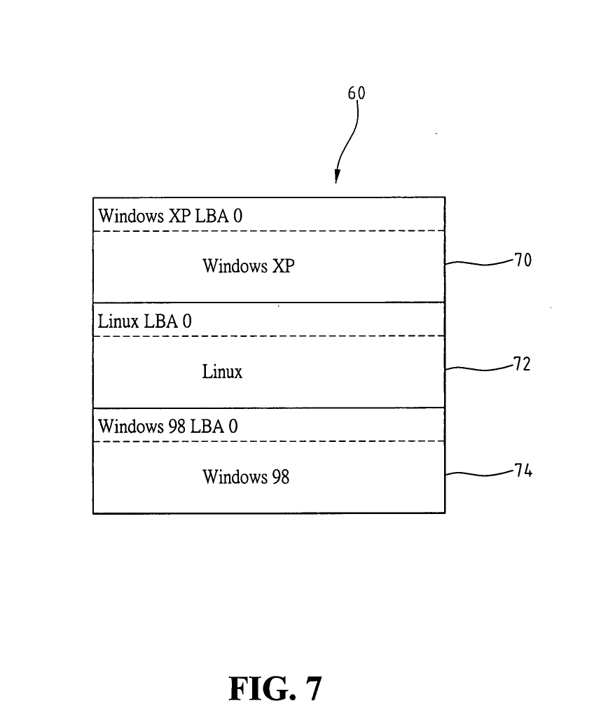

Please refer to FIG. 7, which is a schematic diagram showing the internal space allocation of the hard disk drive 34's working area 60 according to the present invention. As illustrated, the disk controller 32, under the configuration mode, partitions the working area 60 into separate system areas 70, 72, 74, and installs the WindowsXP®, Linux®, and Windows98® operating systems in the system areas respectively. When working in the backup mode, the disk controller 32 copies the operating systems and the data in these system areas into the backup area 64 depicted in FIG. 6.

Therefore, based on the teachings disclosed in the prior art, the WindowsXP® operating system, for example, could only access the storage space within system area 70 of the hard disk drive 34's working area 60.

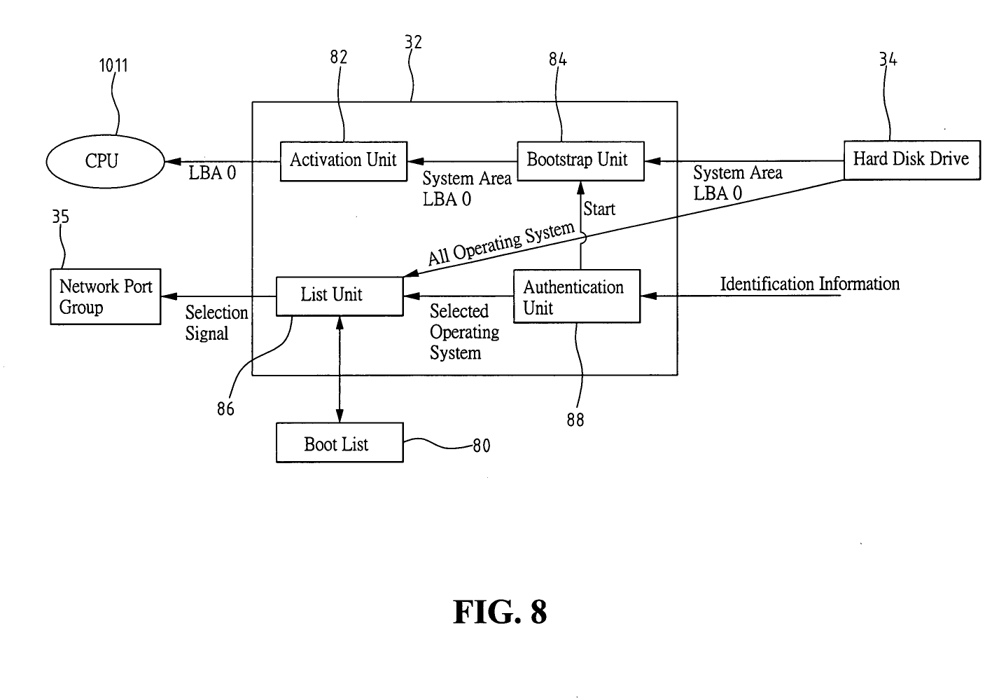

Please refer to FIG. 8, which is a schematic diagram showing the structure of the disk controller 32 according to the present invention. As illustrated, the disk controller 32 contains an activation sub-system (not numbered) which further contains an activation unit 82 and a bootstrap unit 84, and an authentication sub-system (not numbered) which further contains a selection unit 86 and an authentication unit 88. Please note that the two sub-systems are not required to be present at the same time; it is for simplicity sake to put them in the same drawing.

Conventionally, without the activation sub-system, when the computing device 101 is booted up, it will automatically access the physical block 0 on the first track of the hard disk drive 34's first cylinder. With the security device 30 of the present invention, when the computing device 101 is booted up, the disk controller 32 would take control of the hard disk drive 34 under a LBA (logical block addressing) mode by having the activation unit 82 to provide a logical block 0 of the hard disk drive 34 to the CPU 1011, instead of the physical block 0 of the hard disk drive 34. Then, for example, when the user decides to boot the WindowsXP® operating system stored in the system area 70, the bootstrap unit 84 accesses the logical block 0 (shown as LBA 0 in FIG. 7) of the system area 70 and provides it through the activation unit 82 to the CPU 1011. The selected operating system WindowsXP® is thereby booted up.

In summary, the security device 30 of the present invention take controls of the hard disk drive and limits a specific operating system to access only the disk space allocated to that specific operating system. In this way, as each operating system has its own dedicated and independent disk space, there is no installation sequence for these operating systems and their operation wouldn't interfere with each other.

If the authentication sub-system is present in the disk controller 32, the authentication unit 88 would determine whether a user is allowed to boot up the computing device. Within the authentication sub-system, a list unit 86 would first collect information about all operating systems installed in the working area 60 of the hard disk drive 34. The list unit 86 then, based on the collected information, provides a boot list 80 for a user to select a specific operating system. Then an authentication screen would appear, asking the user to supply his or her identification information such as user name and password. A user database could be maintained in the hard disk drive 34, a memory device (not shown), or in a domain identifier device as depicted in FIG. 4. The authentication unit then compares the user supplied identification information with the user database records. Once the user is authenticated to run that specific operating system, the activation unit 84 would provide the logical block 0 (shown as LBA 0 in FIG. 7) in the system area of the specific operating system to the CPU 1011 so that the specific operating system is booted up. In another embodiment, the authentication sub-system could provide the logical block 0 directly to the CPU 1011 without going through the activation sub-system.

In other words, by requiring a user to supply appropriate identification information before allowing the user to operate the computing device 101 in a specific security domain, unauthorized access to a security domain from an unknown user or a user without the required privilege is prohibited. The security device 30 of the present invention thereby achieves a kind of a user firewall.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A security device using multiple operating systems for enforcing security domain policies; said security device being installed in a computing device having a hard disk drive; said security device allowing a user to boot up said computing device with a specific operating system and said operating system communicating only with computing devices within a corresponding domain; and said security device comprising:
a disk controller, wherein said disk controller partitions said hard disk drive into a working area and a backup area; at least two operating systems are installed into separate system areas respectively within said working area under a configuration mode of said disk controller; each system area's operating system and data is backed up to said backup area under a backup mode of said disk controller; said disk controller issues a selection signal when a user chooses to boot up said computing device with a specific operating system; and said disk controller limits said specific operating system to access only its system area; and
a network port group, wherein said network port group comprises at least two network ports; each of said network ports is connected to a specific security domain via a separate network cable respectively; said network port group upon receiving said selection signal limits a currently running operating system to communicate only with its corresponding security domain via a specific network port.

2. The security device as claimed in claim 1, wherein said network port group further comprises:
a port selector, which, upon receiving said selection signal, limits a currently running operating system to communicate only with its corresponding security domain via a specific network port.

3. The security device as claimed in claim 1, wherein said network port group further comprises:
an internal port, wherein said internal port connects to an network adaptor of said computing device via a network cable; and said computing device communicates with a specific security domain via said network adaptor, said internal port, said network port group, and a specific network port.

4. The security device as claimed in claim 1, wherein said network port group connects to a network controller of said security device; said network controller processes packets; and said computing device communicates with a specific security domain via said network controller, said network port group, and a specific network port.

5. The security device as claimed in claim 1, wherein each said security domain further comprises:
a domain identifier device, which issues an identifier packet containing information about said security domain where said domain identifier device is located.

6. The security device as claimed in claim 5, wherein said security device further comprises:
a firewall controller, which, upon receiving said selection signal, examines received identifier packet to determine whether said computing device communicates with a specific security domain as required by an operating system specified by said selection signal.

7. The security device as claimed in claim 1, wherein said disk controller further comprises:
an activation unit, which, when a user boots up said computing device, provides a logical block 0 of said hard disk drive under a logical block addressing mode of said disk controller, instead of a physical block 0 of said hard disk drive; and
a bootstrap unit, which, after a user chooses a specific operating system to boot, provides a logic block 0 of said specific operating system's system area to a CPU of said computing device so as to boot up said computing device with said specific operating system.

8. The security device as claimed in claim 5, wherein said disk controller further comprises:
a list unit, which provides a boot list containing all operating systems installed on said hard disk drive for a user to choose and, after said user making such a selection, issues said selection signal; and
an authentication unit, which examines a user-supplied identification information to determine whether said user is authorized to run said specific operating system and to communicate with a corresponding security domain, and, after authentication, starts said specific operating system.

9. The security device as claimed in claim 8, wherein said authentication is conducted against user information stored in one of the following three locations: said hard disk drive, a memory, and a domain identifier device.

10. The security device as claimed in claim 1, wherein said disk controller further comprises:
an allocation unit, which partitions a plurality of blocks of said hard disk drive into a working area, a pointer area, and a backup area;
a pointer unit, which, when data is written into a block of said working area, records a block status indicating whether said block has been written with data into said pointer area;
a backup unit, which, based on said block status recorded in said pointer area, makes a backup copy of all blocks in said working area having data written and said block status, and saves said backup copy in said backup area; and
a restore unit, which, based on said block status backed up in said backup area, restores all blocks in said working area and all block status in said pointer area according to said backup copy in said backup area.
